(19) United States
(12) Patent Application Publication
(10) Pub. No.: US 2008/0151077 A1
(43) Pub. Date: Jun. 26, 2008

(54) IMAGE PROCESSOR AND IMAGING DEVICE

(76) Inventor: Toshinobu HATANO, Kyoto (JP)

Correspondence Address: MCDERMOTT WILL & EMERY LLP, 600 13TH STREET, NW, WASHINGTON, DC, 20005-3096, US

(21) Appl. No.: 11/959,915

(22) Filed: Dec. 19, 2007

(30) Foreign Application Priority Data
Dec. 26, 2006 (JP) 2006-348903

(51) Int. Cl. H04N 5/262

(52) U.S. Cl. 348/239; 382/118

(57) ABSTRACT

An on-screen data generating section generates on-screen data that becomes a superimposed image that is superimposed on an image displayed based upon a standard digital signal. A data superimposing section superimposes the on-screen data on the standard digital signal. A specific-area detecting section detects a specific area in an image displayed based upon the standard digital signal with the on-screen data superimposed thereon. In such a configuration, the on-screen data generating section generates the on-screen data only from color signal data.

### BACKGROUND OF THE INVENTION

1. Field of the Invention

The present invention relates to an image processor having a specific area detecting function.

2. Description of the Background Art

In recent years, sales of digital camera involving neither a film nor development has been robust, and cell phones of a type with a built-in camera have been in the mainstream, showing that remarkable technical improvement in speed and image quality has been made. In photographing a person, it is of importance to be able to powerfully cope with movements of the person or camera shake during photographing, as well as being able to photograph in a composition that remains unchanged between the times of auto focusing and photographing. Under the present situation, there has been proposed an imaging device as shown in FIG. 3, which detects a face area of a person present within a screen and focuses on the area so as to photograph the person at the optimum exposure for the face area. As for this device, for example, Japanese Patent Application Laid-Open No. 2005-318554 can be referenced.

In the following, the operation of an imaging device shown in FIG. 3 is described. A/D converted image data is stored as first image data, and also subjected to predetermined processing to be stored as second image data. A face area is then detected from the second image data. In the meantime, an image is displayed based upon the A/D converted image data (first image data). Upon completion of detection of the face area, necessary information is extracted from data on a portion corresponding to the face area in the first image data, to perform automatic focusing, automatic exposure control, or a white balance. Thereby the face area is detected from image data for face region detection in photographing sequence, enabling automatic focusing, automatic exposure control, or a white balance to quickly follow movements of the person.

In the above-mentioned conventional imaging device, a frame indicating the face area is displayed on the screen. This on-screen data is generated as luminance signal data and color signal data, and the generated on-screen data is then superimposed respectively on luminance signal data and color signal data of a standard digital signal.

However, since this on-screen data includes the luminance signal data in its constituents, the image data representing the face is completely replaced by the on-screen data representing the frame, which leads to loss of information on the face region or the like in the displayed image, resulting in decreased detection accuracy of a specific area (face etc.). The decrease in detection accuracy in the specific-area detection hinders stability of operation of automatic focusing, automatic exposure control, a white balance, or the like in photographing a person. This also applies to on-screen data on a frame indicating a specific region such as eyes, a nose, cheeks or a mouth for detection of facial expression or dozing.

### SUMMARY OF THE INVENTION

Accordingly, a primary object of the present invention is to improve detection accuracy in specific-area detection.

An image processor according to the present invention includes: a digital signal processing section for generating a standard digital signal for display from image data obtained by A/D converting an imaging signal generated by a two-dimensional image sensor; an on-screen data generating section for generating on-screen data that becomes a superimposed image that is superimposed on an image displayed based upon the standard digital signal; a data superimposing section for superimposing the on-screen data on the standard digital signal; and a specific-area detecting section for detecting a specific area on an image displayed based upon the standard digital signal with the on-screen data superimposed thereon. The on-screen data generating section generates the on-screen data only from color signal data.

As described above, in the case where on-screen data is generated as luminance signal data and color signal data and then superimposed on a standard digital signal, when for example the on-screen data to be used for representing a face of an object, or the like, in image data is completely replaced by original image data, luminance signal data is lost in part of the displayed image. As opposed to this, the on-screen data generating section of the present invention generates on-screen data only from color signal data. Thereby, even when an image is displayed based upon a standard digital signal with this on-screen data superimposed thereon, the on-screen data not accompanied by luminance signal data is displayed in the superimposed form as watermark information on the standard digital signal. Therefore, loss of luminance information is suppressed to the minimum, with the result that process accuracy in a variety of processes using luminance information (specific-area detecting process, etc.) can be kept high.

The present invention has an aspect that the specific-area detecting section detects a specific area of an object present in the image displayed based upon the standard digital signal, and the on-screen data generating section generates, as the on-screen data, on-screen data that shows a frame indicating the specific area or a specific region within this specific area. This permits process accuracy in the specific-area detecting process using luminance information to be kept high.

Further, the present invention has an aspect that the specific-area detecting section detects a face area of the object as the specific area. This permits process accuracy in the process for detecting the face region of the object using luminance information to be kept high.

According to the present invention, on-screen data to be superimposed on a standard digital signal is restricted to color signal data, and thereby, the on-screen data is superimposed on the standard digital signal as watermark information, so that loss of luminance information can be suppressed to the minimum. This leads to improvement in process accuracy (detection accuracy in specific-area detection, etc.) in a variety of processes using luminance information (process for detecting a specific area (a face of an object, etc.). It is therefore possible to stabilize operations of a variety of processes using luminance information (automatic focusing, automatic exposure control, a white balance, etc. in photographing a person). It is also possible to stabilize an operation of an additional function due to detection of a specific area at the time of reproducing an image of a person.

The image processor of the present invention is useful in stably operating automatic focusing, automatic exposure control, or a white balance in a digital camera or a cell phone for taking a high-quality moving picture of a person. It is also useful in stably operating an additional function (face condition determining process) based upon detection of a specific area at the time of reproducing an image of a person.

### BRIEF DESCRIPTION OF THE DRAWINGS

Objects of the present invention other than the above will be apparent as an embodiment described herefrom is understood, and will be clearly shown in the attached claims. A large number of benefits not mentioned in the specification will be conceived by the skilled person in the art if this invention is carried out.

FIG. 1 is a block diagram showing a configuration of an imaging device including an image processor in an embodiment of the present invention;

FIGS. 2A and 2B are conceptual views of display of on-screen data on a face with respect to an image of a person in the embodiment of the present invention.

FIG. 3 is a constitutional view of an image processor including conventional specific-area detection.

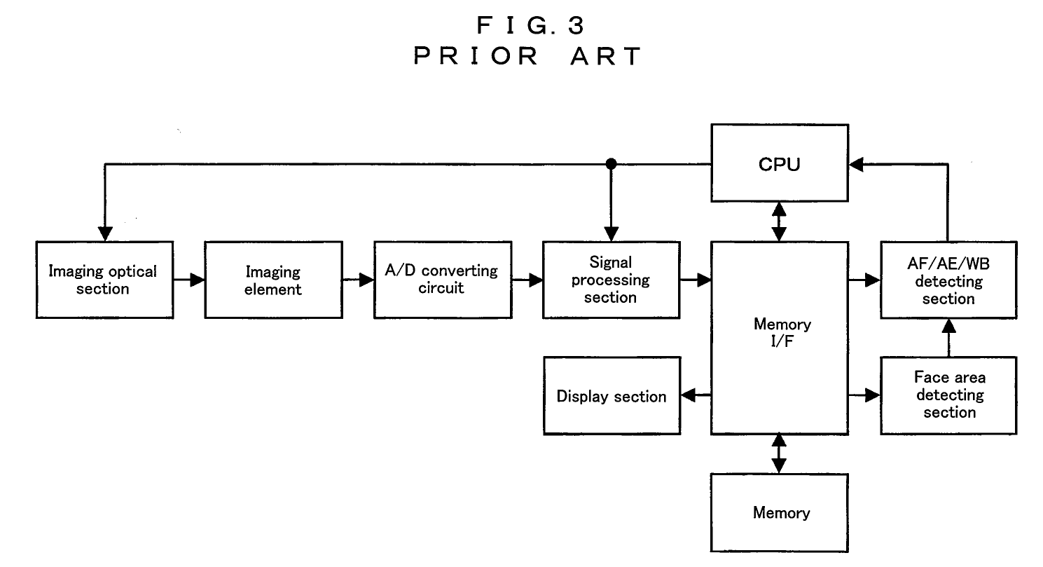

### DETAILED DESCRIPTION OF THE INVENTION

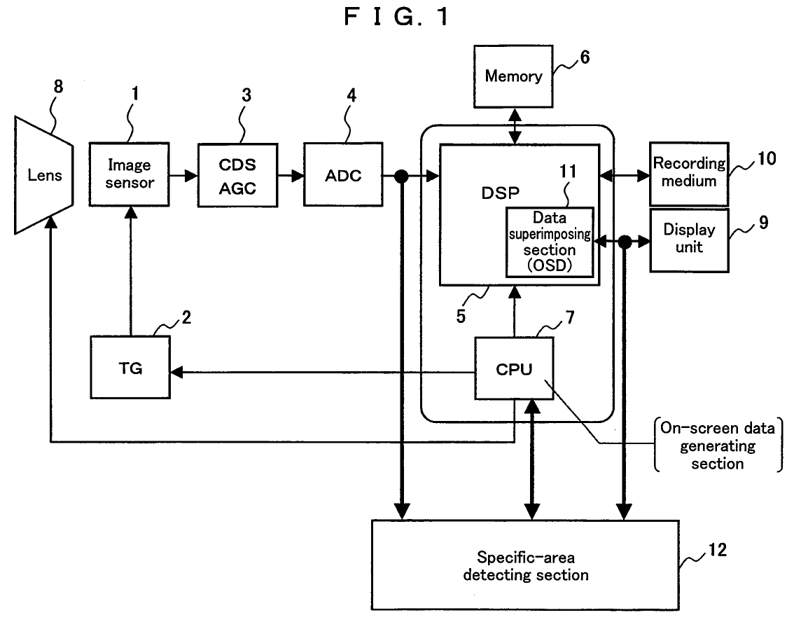

In the following, an embodiment of the image processor according to the present invention is specified with reference to drawings. FIG. 1 is a block diagram showing a configuration of an imaging device including an image processor in the embodiment of the present invention. In FIG. 1, numeral 1 denotes a two-dimensional image sensor; numeral 2 denotes a timing generator (TG) for generating a driving pulse of the two-dimensional image sensor 1; numeral 3 denotes a CDS/AGS circuit for removing noise of an imaged video signal outputted from the two-dimensional image sensor 1 and controlling gains; numeral 4 denotes an A/D converter (ADC) for converting an analog video signal into a digital image data; numeral 5 denotes a digital signal processing circuit (DSP) for executing a variety of processes (including a specific-area detecting process and movement detecting process)through the execution of predetermined programs; numeral 6 denotes a memory for storing the image data and a variety of data; numeral 7 denotes a CPU (microcomputer) for controlling the entire system operation of the imaging device by a control program; numeral 8 denotes a lens unit including a taking lens; numeral 9 denotes a display unit for displaying an image based upon an image output signal; numeral 10 denotes a recording medium for recording a photographed image; numeral 11 denotes a data superimposing section for performing a process for superimposing data on the image output signal (on-screen display function); and numeral 12 denotes a specific-area detecting section for detecting a specific area such as a face area from a luminance signal of image data. The digital signal processing circuit 5 includes the data superimposing section 11 as an internal function of the digital signal processing circuit 5. The CPU 7 includes an on-screen data generating section as an internal function of the CPU 7. It is to be noted that the kind of sensor (CCD, CMOS transistor, etc.) constituting the image sensor 1 is not restricted. In this case, the configuration of the pre-processing sections such as the CDS/AGC circuit 3 and the AD converter 4 are changed as appropriate depending upon the kind of adopted sensor.

The image processor in the embodiment of the present invention includes the digital signal processing circuit 5, the CPU 7, and the specific-area detecting section 12. The specific-area detecting section 12 is supplied with an output of the A/D converter 4 and an image output for display of the digital signal processing circuit 5. The specific-area detecting section 12 is connected to the CPU 7. The on-screen data generating section in the CPU 7 generates on-screen data on a frame indicating the detected specific area or a specific region within the specific area when the specific-area detecting section 12 detects the specific area. The on-screen data generating section generates on-screen data only from color signal data, and transmits the generated on-screen data to the data superimposing section 11.

Next, the operation of the image processor of the present embodiment configured as described above is described. First, a typical recording/reproduction operation of moving picture imaging is described. When an image light is incident on the two-dimensional image sensor 1 through a lens in the lens unit 8, an object image is converted into an electric signal by photodiode or the like, and an imaging video signal as an analog continuous signal is generated by vertical driving and horizontal driving in synchronization with a driving pulse from the timing generator 2. The imaging video signal is outputted from the two-dimensional image sensor 1. The imaging video signal outputted from the two-dimensional image sensor 1 is appropriately reduced in 1/f noise by a sample hold circuit (CDS) of the CDS/AGC circuit 3, and automatically gain-controlled by an automatic gain control circuit (AGC). The imaging video signal subjected to the above processes is supplied to the A/D converter 4. The A/D converter 4 converts the inputted imaging video signal into digital image data (RGB data), and supplies the converted digital image data to the digital signal processing circuit 5. The digital signal processing circuit 5 temporarily records the inputted digital image data in the memory 6, and while reading the data, the digital signal processing circuit 5 performs a variety of signal processes, such as a luminance signal process, a color separation process, a color matrix process, a data shrinking process, and a resizing process. The digital signal processing circuit 5 further resizes the digital image data having been subjected to the signal process to a display size. At this time, the CPU 7 (on-screen data generating section) generates on-screen data made up only of color signal data, the digital signal processing circuit 5 (specifically, the data superimposing section 11 in the digital signal processing circuit 5) downloads on-screen data from the CPU 7, and then superimposes the downloaded on-screen data on digital image data (subjected to resizing process). The digital image data with the on-screen data superimposed thereon is outputted as a standard digital signal of REC 656 from the DSP 5 to the display unit 9. When the digital image data is to be recorded, the DSP 5 supplies the image data to the recording medium 10 so as to be recorded therein. A moving picture is outputted by repetition of the above-mentioned series of processes as continuous moving picture frame operations on a given frame of images.

The conventional on-screen data generating section (CPU) generates, as the on-screen data, on-screen data which is made up of character letters, icons, and the like, and has both luminance signal data and color signal data. The data superposing section partly replaces the on-screen data having such a data configuration with digital image data. As opposed to this, the on-screen data generating section (CPU 7) in the present embodiment generates data made up only of color signal data as on-screen data on a frame indicating a specific area detected by the specific-area detecting section 12 or a specific region within the specific area, and transmits the generated on-screen data to the data superimposing section 11. Further specific description is given below.

In the specific-area detecting section 12, image data in conformity with a format for input into the display unit 9 is inputted, and luminance signal data for specific-area detection is generated in a luminance signal extracting section (not shown) in an internal pre-input process, to extract information of dimensions and inclination on the specific area. The CPU 7 estimates and calculates the specific area within image data for display in the specific-area information supplied from the specific-area detecting section 12. For on-screen display in the estimated specific area, the data superimposing section 11 sets on-screen data of a frame for indicating the whole of the specific area made up of a face and the like of the object or a frame indicating a specific region (a region such as eyes, nose, mouth, cheeks, etc.). At this time, the CPU 7 generates on-screen data only from color signal data.

The data superimposing section 11 superimposes the on-screen data (frame data) generated by the CPU 7 on the standard digital signal obtained by the digital signal processing circuit 5, and outputs the superimposing standard digital signal to the display unit 9. In the display unit 9, the frame is superimposed and displayed so as to be visually checkable by a photographing person. The superimposing standard digital signal is also supplied to the specific-area detecting section 12, and the specific-area detecting section 12 detects a specific area based upon luminance signal data in the superimposing standard digital signal.

In the conventional configuration, since on-screen data is generated as luminance signal data and color signal data, which are respectively superimposed on luminance signal data and color signal data of a standard digital signal, image data representing a specific area is completely replaced by the on-screen data. This results in loss of luminance information in the specific area, thereby decreasing detection accuracy in specific-area detection.

In order to avoid such a disadvantage, in the present embodiment, on-screen data is generated only from color signal data, which is then superimposed on color signal data of a standard digital signal. Thereby, the on-screen data not accompanied by luminance signal data is superimposed as watermark information on the standard digital signal, and the superimposing data is then subjected to a display process. This suppresses loss of face information to the minimum. Consequently, detection accuracy in specific-area detection can be kept. This is because the on-screen data is not accompanied by luminance signal data, thus not affecting the specific-area detection based upon luminance signal data.

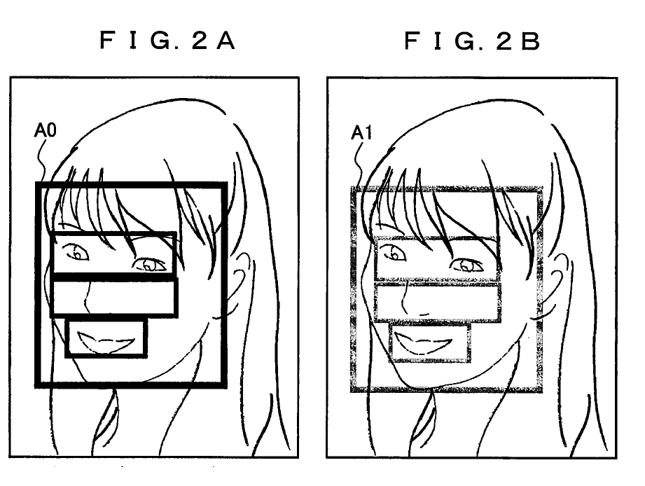

The detection accuracy in the specific-area detection of the present embodiment is further described with reference to FIGS. 2A and 2B. FIG. 2A is a displayed image in the case of generating on-screen data representing a specific area or a specific region as luminance signal data and color signal data, and superimposing this on-screen data on a standard digital signal (related art). In this case, an influence exerted by the luminance signal data appears as a dark color on on-screen data A0, and the on-screen data A0 completely replaces image data of the face or the specific region to cause loss of face information, thus decreasing detection accuracy in specific-area detection.

On the other hand, FIG. 2B is a displayed image in the case of generating on-screen data only from color signal data, and superimposing this on a standard digital signal (present embodiment).

In this case, on-screen data A1 is displayed as watermark information in a displayed image of a standard digital signal, and in the specific-area detecting process, a face can be clearly recognized from image information of luminance signal data of an original image. As thus described as a result of suppressing loss of face information to the minimum, detection accuracy in specific-area detection can be improved more in the configuration of the present embodiment shown in FIG. 2B than in the configuration shown in FIG. 2A.

As thus described, in the present invention,

on-screen data based upon detected specific-area information is superimposed on a standard digital signal, and a specific area is detected while the signal is outputted;

on-screen data is further generated based upon the detected specific-area information;

the generated on-screen data is superimposed on a standard digital signal;

during the superimposition, all the on-screen data including the detected specific-area information is generated only from color signal data within an effective area for imaging a face during a specific area detecting operation.

Therefore, accuracy in specific-area detection further improves.

It is to be noted that on-screen data is generated as luminance signal data and color signal data in the case of not detecting a specific area.

Although the present invention was specifically described regarding the most preferable specific example, combination and arrangement of components in the preferable embodiment can be variously changed without defying the spirit and scope of the present invention which are claimed later.

What is claimed is:

1. An image processor, comprising:
a digital signal processing section for generating a standard digital signal for display from image data obtained by A/D converting an imaging signal generated by a two-dimensional image sensor;
an on-screen data generating section for generating on-screen data that becomes a superimposed image that is superimposed on an image displayed based upon said standard digital signal; and
a data superimposing section for superimposing said on-screen data on said standard digital signal; and
a specific-area detecting section for detecting a specific area on an image displayed based upon said standard digital signal with said on-screen data superimposed thereon,
wherein said on-screen data generating section generates said on-screen data only from color signal data.

2. The image processor according to claim 1, wherein
said specific-area detecting section detects a specific area of an object present in the image displayed based upon said standard digital signal, and
said on-screen data generating section generates, as said on-screen data, on-screen data that shows a frame indicating said specific area or a specific region within this specific area.

3. The image processor according to claim 2, wherein said specific-area detecting section detects a face area of said object as said specific area.

4. An imaging device, comprising:
a two-dimensional image sensor for photographing an object to generate an imaging signal; and
an image processor according to claim 1 for generating a standard digital signal for display from image data obtained by A/D converting said imaging signal, and then superimposing said on-screen data on the generated standard digital signal.
